(19) United States
(12) Patent Application Publication
(10) Pub. No.: US 2001/0015062 A1
(43) Pub. Date: Aug. 23, 2001

(54) Heat-recovery system in a combined-cycle power plant

(76) Inventors: Kurt Fischer, Mellingen (CH); Jean-Pierre Rickli, Uster (CH)

Correspondence Address: BURNS DOANE SWECKER & MATHIS L L P, POST OFFICE BOX 1404, ALEXANDRIA, VA, 22313-1404, US

(21) Appl. No.: 09/780,509

(22) Filed: Feb. 12, 2001

(30) Foreign Application Priority Data
Feb. 14, 2000 (DE) 100 06 497.3

(51) Int. Cl. F02C 6/18

(52) U.S. Cl. 60/39.182

(57) ABSTRACT

A combined-cycle power plant (1) having a gas turbine (2) has a heat-recovery system in which the exhaust gases are directed from the gas turbine (2) into a heat-recovery boiler (6), where their waste heat is used for preheating water from a water or water/steam circuit. Some of the water preheated there is used for preheating fuel for the gas turbine (2). To this end, it flows through a single circuit, the water being extracted from any desired pressure region of the heat-recovery boiler (6) via an extraction line (30, 40) and being fed to a double-tube heat exchanger (31). The fuel for the gas turbine (2) flows in the inner tubes of the double tubes (32) of the heat exchanger (31) and is heated by the preheated water, which flows around the outer tubes. Finally, the water is returned via a return line (35) to the water or water/steam circuit. The preheating by a single circuit makes possible an increased efficiency of the heat recovery. In addition, the use of a double-tube heat exchanger minimizes the safety risk in the event of water or fuel leakages.

The invention relates to a heat-recovery system in a combined-cycle power plant having a gas turbine, the exhaust gases of which, for the purpose of recovering their waste heat, are directed into a heat-recovery boiler. It relates in particular to a heat-recovery system in which the waste heat from the waste gases is partly used for preheating fuel for the gas turbine.

During the combustion of gas or oil for the operation of a gas turbine, exhaust gases of high temperature are produced, the waste heat of which can be utilized. To this end, the exhaust gases are normally directed into a heat-recovery boiler, where their waste heat is recovered by heat exchange. The exhaust gases flow around heating areas there, such as, for example, tubes in which water or steam flows. Steam heated in this way (in the high-temperature region of the heat-recovery boiler) is used, for example, for driving a steam turbine connected downstream of the gas turbine, as process steam, or for injecting into a gas turbine. Water is heated, for example, in the low-temperature region of the heat-recovery boiler and then fed to the water/steam circuit of a steam power plant or is used during the preheating of fuel. A higher efficiency of the gas turbine is achieved by preheating fuel for gas turbines, such as gas or oil, to a predetermined temperature.

Publication EP 0 659 980, for example, discloses a system for preheating fuel for gas turbines. A plurality of heat exchangers are arranged in the heat-recovery boiler of a gas turbine. Condensate from the condenser of a steam turbine is preheated in the low-pressure region of the heat-recovery boiler and fed to a further heat exchanger which is located outside the heat-recovery boiler. There, it flows around tubes in which gas for the operation of the gas turbine flows, and is finally returned to the condenser. Efficient heating of the fuel with few losses is possible in a heat exchanger of this type. However, the operation of such a system has disadvantages. There is a pressure difference between the heating water and the fuel, and the tube walls have to withstand this pressure difference. In the process, mechanical defects may occur at the tubes, as a result of which fuel may pass into the water circuit, a factor which may lead to explosions if gas accumulates in an unfavorable manner. Such a system also entails a safety risk, which requires expensive protective measures in order to reduce it.

Publication EP 0 819 209 discloses a further system for preheating fuel for a gas turbine. Here, the water for heating the fuel is heated in a self-contained intermediate circuit. In this intermediate circuit, water is heated in a heat exchanger by feedwater from the water/steam circuit of a steam turbine, which feedwater has been heated in the intermediate-temperature region of the heat-recovery boiler of the gas turbine. In this system, the water/steam circuit of the steam turbine and the water circuit for preheating the fuel are thus separate from one another, so that there is no safety risk due to water/fuel leakages. However, the system has the disadvantage that additional losses arise due to the intermediate circuit and less heat recovery overall is achieved. Furthermore, the operation of the additional pumps for the intermediate circuit requires more power, as a result of which there is a further deterioration in the energy balance.

The object of the invention, for a combined-cycle plant having a gas turbine, is to provide a system for the recovery of heat from the exhaust gases of the gas turbine, in which the exhaust gases are directed into a heat-recovery boiler and the heat recovered there is used for preheating fuel for the gas turbine. To this end, water from a water circuit or water/steam circuit is to be used, this water having been preheated in preheaters in the heat-recovery boiler. The object is in particular to provide a system for preheating fuel for a gas turbine, the heat-recovery efficiency of which system is optimized and which involves a minimum safety risk.

This object is achieved by a system as claimed in claim 1. The heat-recovery system has a single water circuit for preheating fuel. This circuit contains an extraction line which extracts preheated water from the heat-recovery boiler and directs it to a heat exchanger in which it preheats the fuel for the gas turbine. A further line which is connected to the heat exchanger returns this water, once it has flowed through the heat exchanger, to the water or water/steam circuit. According to the invention, the heat exchanger for preheating the fuel has double tubes with inner and outer tubes, the fuel flowing through the inner tubes and the heating water flowing around the outer tubes. In addition, the extraction line for the water for preheating the fuel is connected to a preheater in any desired pressure region of the heat-recovery boiler.

In a first embodiment of the invention, the extraction line for the water for heating the fuel is connected to a preheater in a low-pressure region of the heat-recovery boiler.

In a second embodiment, the extraction line for this water is connected to a preheater in a high-pressure region of the heat-recovery boiler.

The double-tube heat exchanger has a multiplicity of double tubes with in each case an outer tube and an inner tube, a cavity being located in each case between the two tubes. In the event of a leakage at the inner or outer tube, the fuel or the water passes into this cavity. This prevents the fuel or water from passing directly into the other medium. Direct contamination of the water or an accumulation of gas is thus avoided. A leakage can be detected in this double-tube heat exchanger and rectified without the plant being damaged. As a result, the safety of the system is greatly increased, and protective measures, as are necessary in heat exchangers with single tubes, are now no longer necessary.

The double tubes of the heat exchanger have a plurality of retaining rings along their length between the inner and outer tubes. During the heat exchange, the heat of the water is conducted via the walls of the outer tubes and via the retaining rings to the inner tubes and to the fuel. The retaining rings each have at least one opening, so that the cavity is continuous over the length of the tubes. In the event of a leakage of water through the outer tube or a leakage of fuel through the inner tube, the water or the fuel merely passes into this cavity. A leakage can be detected by means of sensors in these cavities and appropriate measures can be taken in order to rectify it.

Due to the separation of the two media in the heat exchanger by means of a cavity, the problem with the pressure drop between water and fuel and the associated safety risks is mostly removed. This now makes it possible to freely select the extraction location of the water from the water line in the heat-recovery boiler without having to consider safety issues. Water for preheating the fuel may now be used from a region of lower pressure than that in the gas system without the operating safety being jeopardized. As a result, the pressure and temperature of the preheating water can be freely selected. The extraction location can be arranged as desired in the low-temperature region or in the high-temperature region. When determining the extraction location, therefore, only the desired temperature of the fuel and the temperature difference rating of the double-tube heat exchanger are decisive.

After the extraction from the preheating in the heat-recovery boiler, the water for preheating the fuel flows through a single circuit in which its heat is transferred directly and with a single temperature gradient to the fuel. As a result, an intermediate circuit and the losses which are associated with two temperature gradients are avoided.

The system according to the invention permits optimized heat recovery in conjunction with increased operating safety. In addition, the cost of construction and operation of the plant is reduced by avoiding an intermediate circuit and protective devices for reducing safety risks.

In the drawing:

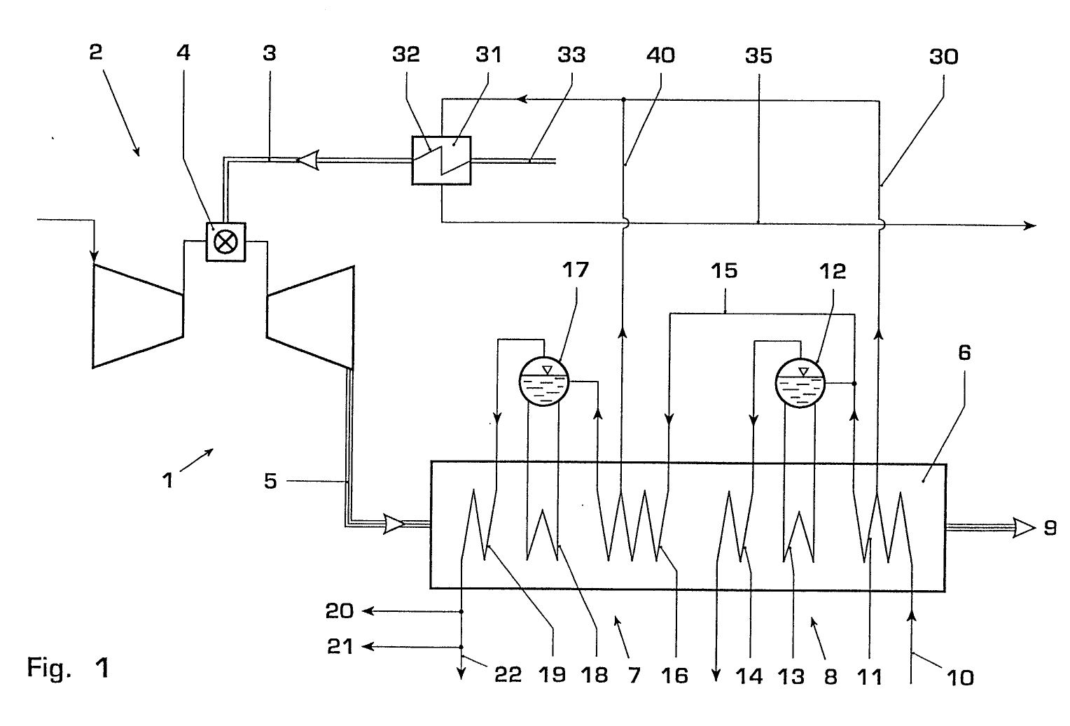

FIG. 1 shows a scheme of a combined-cycle power plant with gas turbine and heat-recovery boiler and a system according to the invention for preheating fuel for the gas turbine,

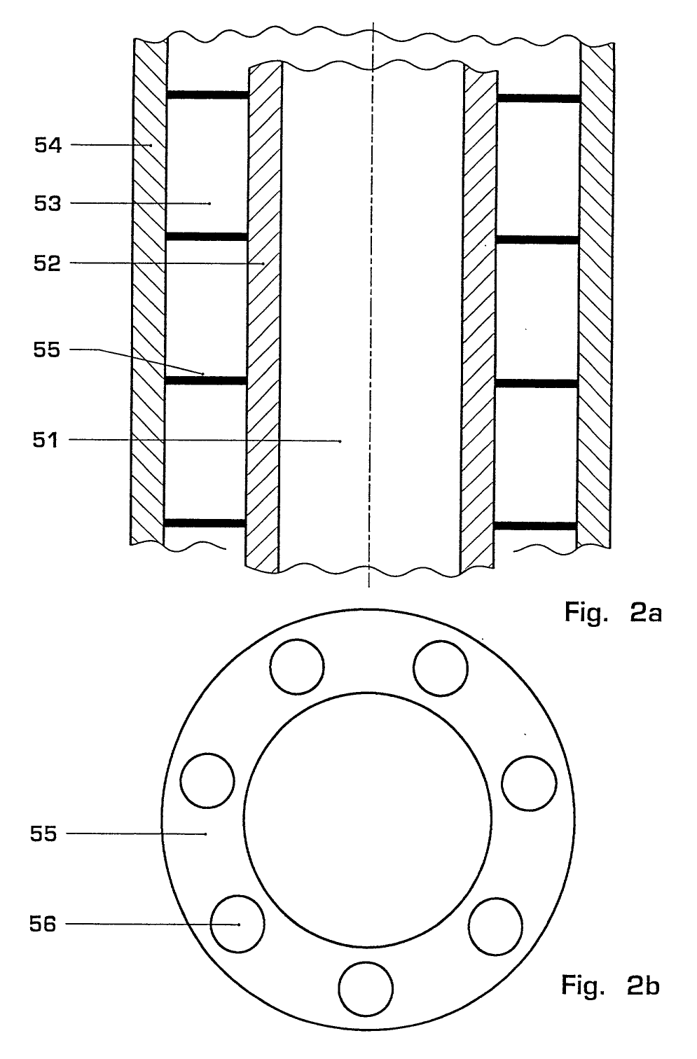

FIG. 2a shows an example of a double tube in a double-tube heat exchanger of the system according to the invention,

FIG. 2b shows an example of a retaining ring in a double tube.

FIG. 1 shows a combined-cycle power plant 1 with a gas turbine 2. The fuel for the gas turbine 2, for example oil or gas, is directed via a line 3 to the combustion chamber 4 of the gas turbine 2. The exhaust gases of high temperature, which are produced during the combustion, are directed via lines 5 into a heat-recovery boiler 6, where their waste heat is delivered to water lines 10. After flowing through the high-temperature region 7 and the low-temperature region 8 of the heat-recovery boiler 6, the cooled exhaust gases pass via a stack 9 to the atmosphere.

A line 10 directs water for heating into a preheater 11 in the low-temperature and low-pressure region 8 of the heat-recovery boiler 6. This water is, for example, condensate or feedwater from the water/steam circuit of a steam turbine or water from the circuit of a district heating power station. In the low-pressure region 8, some of this preheated water is directed into a low-pressure drum 12. As part of the low-pressure region 8 of the heat-recovery boiler 6, a low-pressure evaporator heating area 13, in which low-pressure steam is generated, is connected to this low-pressure drum 12. This low-pressure steam is fed via a steam line 14 to the power plant or to a further system for further use.

A line 15 leads from the preheater 11 in the low-pressure region 7 to the high-pressure region 7 of the heat-recovery boiler 6, in which a preheater 16 and a high-pressure drum 17 with high-pressure evaporator heating area 18 are arranged. The high-pressure steam generated there is directed from the heat-recovery boiler via a steam line 19 and is fed, for example, via a line 20 to the gas turbine for the purpose of injecting in the combustion chamber, via a process-steam line 21 to a further plant or via a line 22 to a steam turbine.

According to the invention, the system for preheating gas turbine fuel has an extraction line 30, via which preheated water is extracted from the preheater 11 and directed to a heat exchanger apparatus 31. This apparatus 31 has, in particular, double tubes 32 with in each case outer tubes and inner tubes. The gas-turbine fuel flows via a feed line 33 through the inner tubes of the apparatus 31 and is fed from there via a line 3 to the combustion chamber 4 of the gas turbine. The water heated by the preheater 11 flows around the outer tubes of the heat exchanger 31, in the course of which it heats the fuel in the inner tubes. The fuel is heated in the double-tube heat exchanger 31 to a temperature of, for example, 140° C. As a result, a higher efficiency is achieved during operation of the gas turbine.

The preheating of the fuel also provides for the fuel to be within a certain temperature range above the dew point of the fuel. This ensures that condensation and damage caused by droplets are prevented. For this purpose, the fuel is heated to a temperature of, for example, 20° C. above the dew point. For the operation of the double-tube heat exchanger, there are minimum restrictions with regard to the pressure of the water and fuel. As already mentioned, this is made possible by the cavity between the outer and inner tubes of the apparatus. If a leakage should occur at one of the tube walls, contamination of the fuel by water or a gas accumulation in the water circuit is virtually impossible thanks to the double tubes. Due to the safety risk being minimized, the water pressures may now be freely selected. The water for heating the fuel may therefore be extracted at any desired point of the heat-recovery boiler. When selecting the extraction location, the only criterion to be taken into account is the desired final temperature of the fuel and the temperature difference rating of the heat exchanger, this temperature difference rating typically being about 15° C.

From this, in an alternative solution of the object, the system according to the invention has a line 40 through which water is extracted from the high-pressure region 7. In this case, the extraction point is located, for example, on the water side at the end of the preheater 16. The water is then fed via the line 40 to the double-tube heat exchanger apparatus 31. Due to this arrangement of the extraction point, the fuel can reach temperatures close to the carbonization point. This permits a further improvement in the efficiency of the gas turbine. Although the water from the high-pressure region has an increased pressure, there is no safety risk with regard to leakages of the two media in the heat exchanger 31 thanks to the use of the double tubes.

After flowing through the double-tube heat exchanger, the water passes into a return line 36, via which it passes into the water or water/steam circuit. This return may be at any desired point with regard to the preheating system and is selected merely according to criteria of feasibility, efficiency and heat recovery, depending on plant configuration.

FIG. 2a shows in detail one of the double tubes 50 which is used in the double-tube heat exchanger. It has an inner tube 51 with a wall 52 through which the fuel for the gas turbine flows. This inner tube 51 is separated from an outer tube 54 by a cavity 53. The outer tube 53 is held by a plurality of retaining rings 55, of which an example is shown in FIG. 2b. In addition, the retaining rings serve to conduct heat from the outer tubes to the inner tubes. The retaining rings 55 have a plurality of openings, as a result of which a continuous cavity is ensured over the entire length of a double tube. In an embodiment of the invention, a sensor, by means of which a leakage of water or fuel can be detected, is arranged in each case in this cavity.

### List of Designations

1 Combined-cycle power plant

2 Gas turbine

3 Line for fuel

4 Combustion chamber

5 Line for exhaust gas

6 Heat-recovery boiler

7 High-pressure region

8 Low-pressure region

9 Stack

10 First water line

11 Low-pressure preheater for water

12 Low-pressure drum

13 Low-pressure evaporator heating area

14 Steam line

15 Line for water

16 High-pressure preheater for water

17 High-pressure drum

18 High-pressure evaporator heating area

19 High-pressure steam line

20 Line to gas turbine

21 Line for process steam

22 Line to steam turbine

30 Extraction line

31 Double-tube heat exchanger apparatus

32 Double tubes

33 Feed line for fuel

35 Return line for water

40 Alternative extraction line

50 Double tube

51 Inner tube

52 Wall

53 Cavity

54 Outer tube

55 Retaining ring

56 Opening

1. A heat-recovery system in a combined-cycle power plant (1) having a gas turbine (2), for which fuel is burned in a combustion chamber (3) and the exhaust gases of which, for the purpose of recovering their waste heat, are directed into a heat-recovery boiler (6) having one or more pressure regions, water being directed from a water circuit or a water/steam circuit into the heat-recovery boiler (6) and being heated there in preheaters (11, 16) in the heat-recovery boiler (6), and the heat-recovery system having a single water circuit for preheating fuel for the gas turbine, having an extraction line which directs water from the heat-recovery boiler (6) to a heat exchanger in which the fuel for the gas turbine (2) is heated, and a return line (35) which returns the water to the water or water/steam circuit, characterized in that the extraction line (30, 40) for the water for preheating the fuel is connected to a preheater (11, 16) in any desired pressure region of the heat-recovery boiler (6), and the heat exchanger (31) for preheating the fuel is a double-tube heat exchanger (31), the double tubes (32) of which in each case have an inner tube (51) and an outer tube (54), the fuel in each case flowing in the inner tube (51) and the heating water flowing around the outer tubes (54).

2. The heat-recovery system in a combined-cycle power plant (1) as claimed in claim 1, characterized in that the extraction line (30) for the water for preheating the fuel is connected to the preheater (11) in a low-pressure region (8) of the heat-recovery boiler (6).

3. The heat-recovery system in a combined-cycle power plant (1) as claimed in claim 1, characterized in that the extraction line (40) for the water for preheating the fuel is connected to the preheater (16) in a high-pressure region (7) of the heat-recovery boiler (6).

4. The heat-recovery system in a combined-cycle power plant (1) as claimed in claim 2 or 3, characterized in that the inner tube (51) of a double tube (32) is in each case separated from the outer tube (32) by a cavity (53) in which retaining rings (55) are arranged, which each have at least one opening (56).

5. The heat-recovery system in a combined-cycle power plant (1) according to claim 4, characterized in that in each case sensors are arranged in the cavity (53) between the inner tube (51) and the outer tube (54) of a double tube (32) of the heat exchanger (31) for detecting a leakage of water or fuel into the cavity (53).

6. The heat-recovery system in a combined-cycle power plant (1) as claimed in claim 5, characterized in that the fuel for the gas turbine (2) contains gas or oil.
